(19) United States
(12) Patent Application Publication
(10) Pub. No.: US 2005/0081227 A1
(43) Pub. Date: Apr. 14, 2005

(54) Spindle motor

(76) Inventor: Cheng-Chieh Chuang, Sanchong City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/960,821

(22) Filed: Oct. 7, 2004

(30) Foreign Application Priority Data
Oct. 7, 2003 (TW) 92127891

(51) Int. Cl. G11B 23/00; G11B 25/00; G11B 17/028; G11B 17/03; G11B 19/20

(52) U.S. Cl. 720/700

(57) ABSTRACT

A spindle motor includes a base, a rotor, a rotating shaft, a first turntable, and a second turntable. The rotating shaft is rotatably disposed on the base. The rotor having a top surface is disposed on the rotating shaft, part of which projects from the top surface of the rotor. The first turntable is disposed on the rotating shaft. The second turntable having a disk mounting surface is adjustably disposed over the first turntable, and is arranged to be rotated with the first turntable synchronously.

This application claims the benefit of Taiwan application Serial No. 092127891, filed Oct. 7, 2003, the subject matter of which is incorporated herein by reference.

### BACKGROUND OF THE INVENTION

1. Field of the Invention

The invention relates in general to a spindle motor, and more particularly to the spindle motor having the adjustment means, which is used for adjusting the angle between the disk mounting surface and the rotating shaft.

2. Description of the Related Art

An optical disk driving device consists of an optical pickup and a spindle motor at least. When a mounted disk is rotated at high speed by the spindle motor, the optical pickup will move step-by-step to read the data on the disk. However, phenomena of focusing inaccuracy and tracking error happen when the disk rotates or wobbles, which cause the failure to read the data on the disk. Therefore, in order to improve the quality of the optical signal, it is required to elevate the precision of optical disk driving device. The failure of the optical signal comes mainly from the tile, wobble, and de-center of the spindle motor. Although some of the conventional designs have solved the condition of tile and de-center, the wobbling condition is still a problem. The following illustration depicts the way the spindle motor wobbles.

Please refer to FIG. 1, which illustrates a cross-sectional view of a conventional spindle motor in wobbling. As shown in FIG. 1, the spindle motor 10 consists of at least a base 12, a rotor 14, a rotating shaft 16, and a turntable 18. The rotating shaft 16 is rotatably deposited at the base 12. The rotor 14 having an upper surface 14a is disposed on the rotating shaft 16. A part of the rotating shaft 16 protrudes above the upper surface 14a of the rotor 14. The turntable 18 disposed on the rotating shaft 16 rotates simultaneously with the rotor 14. There is a disk mounting surface 18a of the turntable 18 in use for mounting a disk. Due to the structure of turntable 18, the disk mounting surface 18a fails in the vertical alignment to the rotating shaft 16, which makes the distance between the optical pickup and the outside part of the disk on the disk mounting surface 18a longer or shorter than the working distance. The optical pickup thus fails to read the data on the disk due to optical aberration such as comma, tracking issue and other cross-talk issue etc.

Please refer to FIG. 2, which illustrates a lateral view of another conventional spindle motor in wobbling. The spindle motor 20 consists of at least a base 12, a rotor 14, a rotating shaft 16 and a turntable 28. The rotating shaft 16 is disposed rotatably on the base 12. The rotor 14 having an upper surface 14a is disposed on the rotating shaft 16. A part of the rotating shaft 16 protrudes above the upper surface 14a of the rotor 14. The turntable 28 disposed on the rotating shaft 16 is rotated simultaneously with the rotor 14. There is a disk mounting surface 28a of the turntable 28 for mounting a disk. Because the turntable 28 is connected with rotating shaft 16 in an inclined way, the disk mounting surface 28a is not vertical to the rotating shaft 16.

As FIG. 3 illustrates, some manufacturers deal with the wobbling problem by extra processing. The spindle motor 30 consists of at least a base 12, a rotor 14, a rotating shaft 16 and a turntable 38. After pressing the turntable 38 into the rotating shaft, an extra process, for example, the knife machining 40 on the disk mounting surface 38a, is used for reducing the extent of wobbling of the spindle motor 30. However, this extra process adds to the cost of the tools of knife machining. Also, the accuracy of the spindle motor can reach only 0.03 mm within this bias the spindle motor wobbles or within this bias the upper surface is in distance with the base. The pickup still cannot read the data on the disk, and the failure problem remains. Therefore, it is of great urgency to development the technology to solve the wobbling problem of the spindle motor.

### SUMMARY OF THE INVENTION

It is therefore an object of the invention to provide a spindle motor comprising the second turntable and the adjustment means. The angle between the rotating shaft and the disk mounting surface positioned on the second turntable is easily adjustable, and it provides a solution to the spindle motor for wobble problem.

The invention achieves the above-identified objects by providing a spindle motor, at least including a base, a rotor, a rotating shaft, a first turntable, and a second turntable. The rotating shaft is rotatably disposed on the base. The rotor having a top surface is disposed on the rotating shaft, part of which projects from the top surface of the rotor. The first turntable is disposed on the rotating shaft. The second turntable having a disk mounting surface is adjustably disposed over the first turntable, and is arranged to be rotated with the first turntable synchronously.

The invention achieves the above-identified objects by providing an optical disk driving device having a spindle motor. The spindle motor of the optical disk driving at least including a base, a rotor, a rotating shaft, a first turntable, and a second turntable The rotating shaft is rotatably disposed on the base. The rotor having a top surface is disposed on the rotating shaft, part of which projects from the top surface of the rotor. The first turntableis disposed on the rotating shaft. The second turntable, which has a disk mounting surface, is adjustably disposed over the first turntable, and is arranged to be rotated with the first turntable synchronously.

The invention achieves the above-identified objects by providing a turntable disposed on a rotating shaft. The turntable at least includes a first turntable, a second turntable and an adjustment means. The first turntable is disposed on the rotating shaft. The second turntable having a disk mounting surface is adjustably disposed over the first turntable, and is arranged to be rotated with the first turntable synchronously.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a cross-sectional view of a conventional spindle motor while wobbling.

FIG. 2 (Prior Art) is a cross-sectional view showing another conventional spindle motor while wobbling.

FIG. 3 (Prior Art) is a cross-sectional view showing a conventional machining method used for slightly improving the spindle motor from wobbling.

FIG. 4 schematically illustrates a perspective view of a spindle motor in accordance with the first embodiment of the invention.

FIG. 5 schematically illustrates a top view of the spindle motor shown in FIG. 4.

FIG. 6 schematically illustrates a cross-section view of the spindle motor taken along line 6-6′ of FIG. 5.

FIG. 7 schematically illustrates a cross-section view of the spindle motor taken along line 7-7′ of FIG. 5.

FIG. 8 schematically illustrates a cross-sectional view of the spindle motor having several elastic objects between the first turntable and the second turntable of FIG. 7.

FIG. 9 schematically illustrates a cross-sectional view of the spindle motor having an elastic stuff between the first turntable and the second turntable of FIG. 7.

FIG. 10 schematically illustrates a perspective view of a spindle motor in accordance with the second embodiment of the invention.

FIG. 11 schematically illustrates a perspective view of a spindle motor in accordance with the third embodiment of the invention.

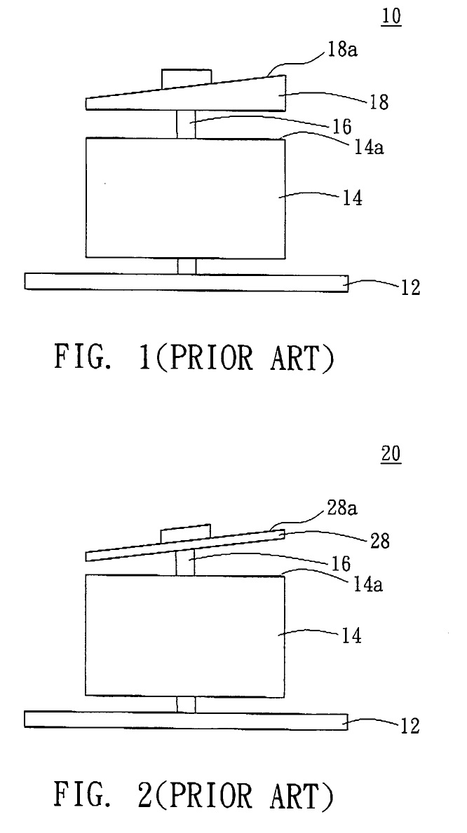

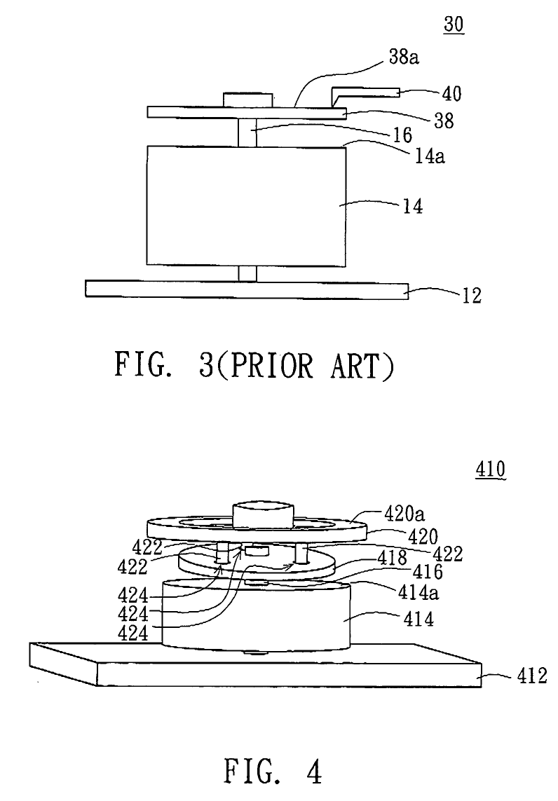

### DETAILED DESCRIPTION OF THE INVENTION

First Embodiment

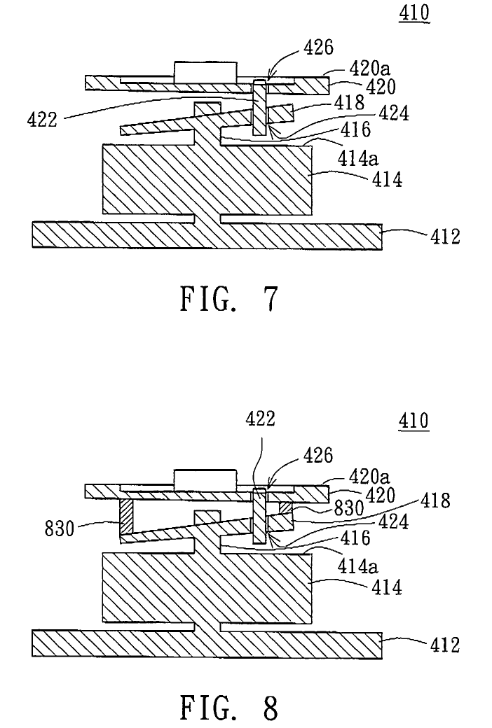

FIG. 4˜FIG. 7 are the drawings for illustrating the first embodiment of the invention. Referring to FIG. 4, a perspective view of a spindle motor in accordance with the first embodiment of the invention. The spindle motor 410 at least includes a motor base 412, a rotor 414, a first turntable 418, a rotating shaft 416, and a second turntable 420. The rotating shaft 416 is rotatably disposed on the base 412. The rotor 414 having a top surface 414a is disposed on the rotating shaft 416, part of which projects form the top surface 414a of the rotor 414. The first turntable 418 is disposed on the rotating shaft 416 and positioned over the rotor 414. The top surface of the first turntable 418 may be perpendicular to the rotating shaft 416 or be inclined defined by the rotating shaft 416; for example, the first turntable 41 should be 418 is not perpendicular to the rotating shaft 416 as shown in FIG. 4. The first turntable 418 is arranged to be rotated with the rotor 414 at the same speed. The second turntable 420 having a disk mounting surface 420a is adjustably disposed over the first turntable 418 i.e. the second turntable 420 could be adjusted to be parallel to the first turntable 418 as shown in FIG. 6 or to be tilted to the first turntable 418 as shown in FIG. 7. A spacing gap exists between the first turntable 418 and the second turntable 420. The axial center of the second turntable 420 is relatively disposed to the axial center of the first turntable 418. This arrangement allows the second turntable 420 to rotate with the first turntable 418 at the same speed.

In the first embodiment of the invention, the spindle motor 410 also comprises an adjustment means. The adjustment means is disposed between the first turntable 418 and the second turntable 420 for adjusting an angle between the disk mounting surface 420a of the second turntable 420 and the rotating shaft 416. For example, the angle between the disk mounting surface 420a of the second turntable 420 and the rotating shaft 416 can be adjusted to 90 degree by the adjustment means. While rotating, the first turntable 418 and the second turntable 420, which are connected by the adjustment means, rotate as a whole. There are several kinds of the adjustment means could be used herein, and described in detail later.

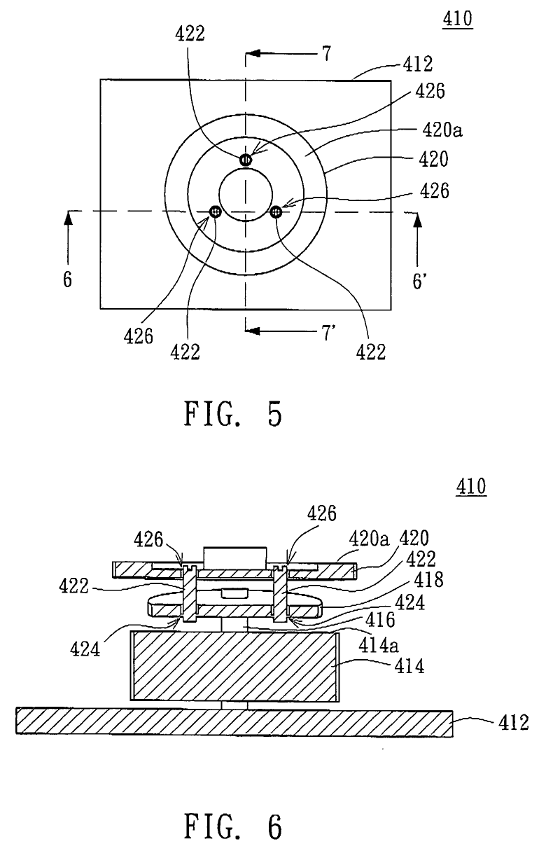

FIG. 5 schematically illustrates a top view of the spindle motor shown in FIG. 4. FIG. 6 schematically illustrates a cross-section view of the spindle motor taken along line 6-6′ of FIG. 4. FIG. 7 schematically illustrates a cross-section view of the spindle motor taken along line 7-7′ of FIG. 4. As shown in FIG. 5˜FIG. 7, several adjustment rods 422 are used as the adjustment means in the first embodiment. The first turntable 418 and the second turntable 420 respectively have several first positioned holes 424 and several second positioned holes 426 arranged opposite as shown in FIGS. 6 and 7. During the process of being mounting the second turntable 420 on the first turntable 418, initially one end of the adjustment rods 422 is inserted into the first positioned holes 424, and the other end is inserted into the second positioned holes 426. After connecting the first turntable 418 and the second turntable 420 by the adjustment rods 422, the horizontal deflection of the disk mounting surface 420a positioned on the second turntable 420 is equalizes by adjusting the adjustment rods 422 with a level. When the disk mounting surface 420a is calibrated to be perpendicular to the rotating shaft 416, two ends of the adjustment rods 422 are fixed to the first positioned holes 424 and the second positioned holes 426 with glues to keep the preferably vertical condition for operation. Moreover, it is only the second turntable has positioned holes that also be feasible. One end of the adjustment rod is passed through the positioned hole on the second turntable, and the other end of the adjustment rod is contact the upper surface of the first turntable. By such arrangement, the disk mounting surface of second turntable are also adjustable relatively to the rotating shaft for keep the preferably vertical condition for opertation. In the practical application, the adjustment means could further comprises the elastic objects nearby the adjustment rods 422. FIG. 8 shows a cross-sectional view of the spindle motor having several elastic objects between the first turntable and the second turntable of FIG. 7. The adjustment means further comprises several elastic objects 830 for the purpose of preventing relative displacement between the first turntable 418 and the second turntable 420. The elastic objects 830 disposed between the first turntable 418 and the second turntable 420 can be nearby the adjustment rods 422. The elastic objects 830 could be several springs, several elastic plates or a combination thereof. Besides, the elastic objects 830 could be made of rubber.

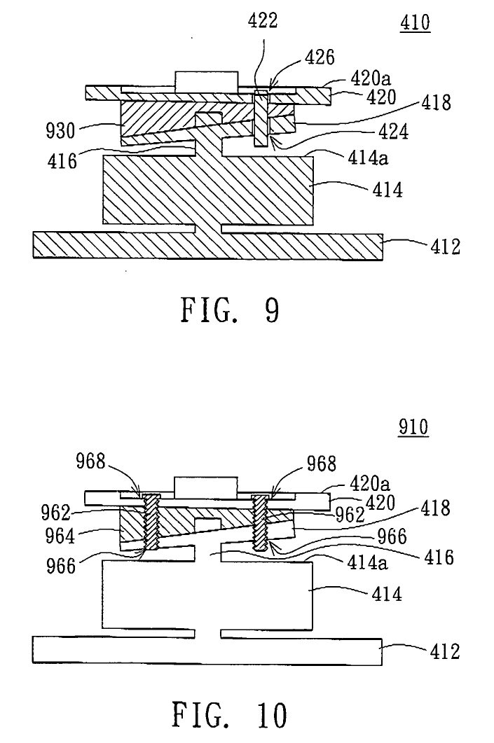

Alternatively, the adjustment means could further comprises an elasticstuff surrounding the adjustment rods 422 for a better operation. FIG. 9 shows a cross-sectional view of the spindle motor having an elastic stuff between the first turntable and the second turntable of FIG. 7. The elastic stuff 930 filling the space between the first turntable 418 and the second turntable 420 surrounds the adjustment rods 422, for the purpose of preventing relative displacement of the first turntable 418 and the second turntable 420. The elastic stuff 930 can be made of rubber.

According to the disclosure of the first embodiment of the invention, it provides a solution to the conventional wobble, runout and tile problem. The use of the second turntable 420 and the adjustment means provide a simple and fast method for equalizing the horizontal deflection of the disk mounting surface 420a that horizontal deflection is equalized. Therefore, while the disk carried by the disk mounting surface 420a is rotated at the high speed, the space between the optical pickup and the disk would not be changeable and can be controlled within the focus working distance. Thus, the data on the disk can be continuously read by the optical pickup.

Second Embodiment

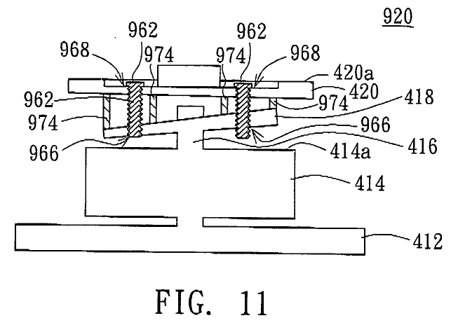

Referring to FIG. 10, a perspective view of a spindle motor in accordance with the second embodiment of the invention. The difference between the spindle motor 910 of the second embodiment and the spindle motor 410 of the first embodiment is the adjustment means, and the rest parts of the spindle motor 910 are signed identically. In the second embodiment, the first turntable 418 and the second turntable 420 respectively have several first spiral holes 966 and several second spiral holes 968, both of which are opposite relatively. The adjustment means further comprises an elastic stuff 964 and several screws 962.

In the arranged process, the elastic stuff 964 fills the space between the first turntable 418 and the second turntable 120 initially, but there are several through holes which provide the screws 962 with room for passing across. Then, the screws 962, which are across the second holes 968 and the elastic stuff 964, is secured in the first spiral holes 966. After connecting the first turntable 418 and the second turntable 420 by the screws 962, the horizontal deflection of the disk mounting surface 420a positioned on the second turntable 420 is equalizes by tightening or loosening the screws 962 with a level. Simultaneously, the elastic stuff 964 provides a elastic tension against the first turntable 418 and the second turntable 420. When the disk mounting surface 420a is calibrated to be perpendicular to the rotating shaft 416, the screws 962 are fixed to the first spiral holes 966 to keep the preferred condition for operation. Besides, the elastic stuff 964 is preferably made of rubber. It is to be understood that the elastic stuff 964 of the second embodiment can be omitted, since the use of the screws 962, the first spiral holes 966 and the second spiral holes 968 achieves the same effect, that is, making the disk mounting surface 420a to be vertical to the rotating shaft 416.

Third Embodiment

Referring to FIG. 11, a perspective view of a spindle motor in accordance with the third embodiment of the invention. The difference between the spindle motor 920 in the third embodiment and the spindle motor 910 in the second embodiment is the adjustment means, and the rest parts of the spindle motor 920 are signed identically. In the third embodiment, the adjustment means further comprises several elastic objects 974 and several screws 962. In the arranged process, the elastic objects 974 is disposed between the first turntable 418 and the second turntable 420 initially, and there is some space between the first turntable 418 and the second turntable 420 for passing the screws 962 across. Then, the screws 962, which are across the second spiral holes 968, is secured in the first spiral holes 966. After connecting the first turntable 418 and the second turntable 420 by the screws 962, the horizontal deflection of the disk mounting surface 420a positioned on the second turntable 420 is equalizes by tightening or loosening the screws 962 with a level. Simultaneously, the elastic objects 974 provides a elastic tension against the first turntable 418 and the second turntable 420. When the disk mounting surface 420a is calibrated to be perpendicular to the rotating shaft 416, the screws 962 are fixed to the first spiral holes 966 to keep the preferred condition for operation. Besides, these elastic objects 974 could be several springs, the elastic plates or a combination thereof. These elastic objects 974 are preferably made of rubber. It is to be understood that the elastic objects 974 of the third embodiment can be omitted. The use of the screws 962, the first spiral holes 966 and the second spiral holes 968 also achieves the same effect, that is, making the disk mounting surface 420a to be vertical to the rotating shaft 416.

According to the aforementioned descriptions, the spindle motor equipped with the second turntable and the adjustment means can well adjust the angle between the rotating shaft and the disk mounting surface. Thus, the conventional wobble problem can be solved. Moreover, without machining the disk mounting surface by knife and examining whether the first turntable is perpendicular to the rotating shaft, the manufacturing time and production cost can be greatly reduced.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A spindle motor, comprising:
a base;
a rotating shaft, rotatably disposed on the base;
a rotor having a top surface, mounted on the rotating shaft, and a part of the rotating shaft projecting from the top surface of the rotor;
a first turntable, disposed over the rotating shaft; and
a second turntable having a disk mounting surface, adjustably disposed over the first turntable and arranged to be rotated with the first turntable synchronously.

2. The spindle motor according to claim 1 further comprising an adjustment means, disposed between the first turntable and the second turntable for adjusting an angle between the disk mounting surface of the second turntable and the rotating shaft.

3. The spindle motor according to claim 2, wherein the first turntable and the second turntable respectively comprise a plurality of first positioned holes and a plurality of second positioned holes arranged relatively, and the adjustment means comprising:
a plurality of adjustment rods, two ends of the adjustment rods respectively fixed to the first positioned holes and the second positioned holes for adjusting the angle between the disk mounting surface and the rotating shaft.

4. The spindle motor according to claim 2, wherein the second turntable comprise a plurality of positioned holes, and the adjustment means comprising:
a plurality of adjustment rods, one end of the adjustment rods adjustably inserted to the positioned holes and the other end of the adjustment rods contacted to the first turntable for adjusting the angle between the disk mounting surface and the rotating shaft.

5. The spindle motor according to claim 2, wherein the first turntable and the second turntable respectively comprise a plurality of the first spiral holes and a plurality of the second spiral holes arranged relatively, and the adjustment means comprises:
a plurality of screws, inserted through the second spiral holes and secured in the first spiral holes for adjusting the angle between the disk mounting surface and the rotating shaft.

6. The spindle motor according to claim 2, wherein the second turntable respectively comprise a plurality of the spiral holes, and the adjustment means comprises:
a plurality of screws, one end of the screws inserted through the spiral holes and the other end of the screws contacted to the first turntable for adjusting the angle between the disk mounting surface and the rotating shaft.

7. The spindle motor according to claim 2 further comprises a plurality of elastic objects disposed between the first turntable and the second turntable and positioned nearby the adjustment means.

8. The spindle motor according to claim 7, wherein the elastic objects are a plurality of springs.

9. The spindle motor according to claim 7, wherein the elastic objects are a plurality of elastic plates or plastic material.

10. The spindle motor according to claim 7, wherein the elastic objects are made of rubber.

11. The spindle motor according to claim 2, wherein the adjustment means further comprises an elastic stuff, filling between the first turntable and the second turntable and surrounding the adjustment means.

12. The spindle motor according to claim 11, wherein elastic stuff is made of rubber.

13. An optical disk driving device, having a spindle motor for rotating an optical disk at high speed, and the spindle motor at least comprising:
a base;
a rotating shaft, rotatably disposed on the base;
a rotor having a top surface, mounted on the rotating shaft, and the part of the rotating shaft projecting from the top surface;
a first turntable, disposed over the rotating shaft; and
a second turntable having a disk mounting surface, adjustably disposed over the first turntable and arranged to be rotated with the first turntable synchronously.

14. The optical disk driving device according to claim 13 further comprising:
a adjustment means, disposed between the first turntable and the second turntable for adjusting the angle between the disk mounting surface and the rotating shaft.

15. The optical disk driving device according to claim 14, wherein the first turntable and the second turntable respectively comprise a plurality of first positioned holes and a plurality of second positioned holes arranged relatively, and the adjustment means comprising:
a plurality of adjustment rods, two ends of the adjustment rods respectively inserted to the first positioned holes and the second positioned holes for adjusting the angle between the disk mounting surface and the rotating shaft.

16. The optical disk driving device according to claim 14, wherein the second turntable respectively comprise a plurality of positioned holes, and the adjustment means comprising:
a plurality of adjustment rods, one end of the adjustment rods adjustably inserted to the positioned holes and the other end of the adjustment rods contacted to the first turntable for adjusting the angle between the disk mounting surface and the rotating shaft.

17. The optical disk driving device according to claim 14, wherein the first turntable and the second turntable respectively comprise a plurality of the first spiral holes and a plurality of the second spiral holes arranged relatively, and the adjustment means comprises:
a plurality of screws, inserted through the second spiral holes and secured in the first spiral holes for adjusting the angle between the disk mounting surface and the rotating shaft.

18. The optical disk driving device according to claim 14, wherein the second turntable comprise a plurality of the spiral holes, and the adjustment means comprises:
a plurality of screws, one end of the screws inserted through the spiral holes and the other end of the screws contacted to the first turntable for adjusting the angle between the disk mounting surface and the rotating shaft.

19. A turntable assembly, at least comprises:
a first turntable, disposed over the rotating shaft; and
a second turntable having a disk mounting surface, adjustably disposed over the first turntable and arranged to be rotated with the first turntable synchronously.

20. The turntable assembly according to claim 19 further comprising:
a adjustment means, disposed between the first turntable and the second turntable for adjusting the angle between the disk mounting surface and the rotating shaft.

21. The turntable assembly according to claim 20, wherein the first turntable and the second turntable respectively comprise a plurality of first positioned holes and a plurality of second positioned holes arranged relatively, and the adjustment means comprising:
a plurality of adjustment rods, two ends of the adjustment rods respectively inserted to the first positioned holes and the second positioned holes for adjusting the angle between the disk mounting surface and the rotating shaft.

22. The turntable assembly according to claim 20, wherein the second turntable respectively comprise a plurality of positioned holes, and the adjustment means comprising:
a plurality of adjustment rods, one end of the adjustment rods adjustably inserted to the positioned holes and the other end of the adjustment rods contacted to the first turntable for adjusting the angle between the disk mounting surface and the rotating shaft.

23. The turntable assembly according to claim 20, wherein the first turntable and the second turntable respectively comprise a plurality of the first spiral holes and a plurality of the second spiral holes opposed mutually, and the adjustment means comprises:
a plurality of screws, inserted through the second spiral holes and secured in the first spiral holes for adjusting the angle between the disk mounting surface and the rotating shaft.

24. The turntable assembly according to claim 20, wherein the second turntable comprise a plurality of the spiral holes, and the adjustment means comprises:
a plurality of screws, one end of the screws inserted through the spiral holes and the other end of the screws contacted to the first turntable for adjusting the angle between the disk mounting surface and the rotating shaft.
